(19) United States
(12) Patent Application Publication
(10) Pub. No.: US 2021/0020056 A1
(43) Pub. Date: Jan. 21, 2021

(54) SYSTEM AND METHOD FOR AN AUTOMATIC NOTIFICATION OF AN AIRCRAFT TRAJECTORY ANOMALY

(71) Applicant: HONEYWELL INTERNATIONAL INC., Morris Plains, NJ (US)

(72) Inventors: Rajesh Chenchu, Tirupati (IN); Amit Srivastav, Bangalore (IN); Raju Siravuri, Hyderabad (IN); SivaPrasad Kolli, Hyderabad (IN)

(73) Assignee: HONEYWELL INTERNATIONAL INC., Morris Plains, NJ (US)

(21) Appl. No.: 16/513,219

(22) Filed: Jul. 16, 2019

(51) Int. Cl. G08G 5/02; G08G 5/00; G07C 5/00

(52) U.S. Cl. CPC G08G 5/025; G07C 5/008; G08G 5/0013

(57) ABSTRACT

A system for detecting aircraft trajectory anomalies during takeoff or landing is configured to: identify, from a clearance message directed to a first aircraft, an approved runway and an approved landing or takeoff procedure; select a runway-specific trained model appropriate for the approved procedure, the selected trained model having been trained with historical track data from other aircraft performing the approved procedure in connection with the approved runway, the selected trained model configured to provide an expected trajectory for an aircraft during performance of the approved procedure in connection with the approved runway; receive aircraft state information from the first aircraft during performance of the approved procedure; monitor and compare the received aircraft state information to the expected trajectory from the trained model; identify an anomaly and generate an alert when the trajectory of the first aircraft deviates from the expected trajectory by more than a predetermined threshold level.

### TECHNICAL FIELD

The present invention generally relates to air traffic safety systems, and more particularly relates to systems for monitoring aircraft movement around an airdrome.

### BACKGROUND

Once air traffic control (ATC) provides clearance to an aircraft to approach, land, taxi, or takeoff at an airport, it is up to the flight crew to ensure that execution of the approved procedure is appropriate with respect to an approved runway. If the airplane attempts to enter the wrong runway, for example due to pilot error, a collision with another aircraft could occur. There is no automatic mechanism for monitoring an aircraft's trajectory and providing an alert if there is a trajectory anomaly with respect to an assigned runway.

Hence, it is desirable to provide a system for monitoring aircraft trajectory during approach, landing, taxiing or takeoff. Furthermore, other desirable features and characteristics of the present invention will become apparent from the subsequent detailed description and the appended claims, taken in conjunction with the accompanying drawings and the foregoing technical field and background.

### SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A processor-implemented system for detecting trajectory anomalies during takeoff or landing at an airdrome is disclosed. The system includes one or more processors configured by programming instructions on computer readable media. The system is configured to: identify, from a received clearance message directed to a first aircraft, an approved runway and an approved landing or takeoff procedure for the first aircraft; select a runway-specific trained model appropriate for the approved procedure, the selected trained model having been trained with historical track data from other aircraft performing the approved procedure in connection with the approved runway, the selected trained model configured to provide an expected trajectory for an aircraft at different points during performance of the approved procedure in connection with the approved runway; receive aircraft state information from the first aircraft at a plurality of times during performance by the first aircraft of the approved procedure; monitor the received aircraft state information to determine the existence of an anomaly by comparing the received aircraft state information to expected trajectory information from the trained model; detect an anomaly when the trajectory of the first aircraft deviates from the expected trajectory provided by the selected model by more than a predetermined threshold level; and generate an alert responsive to detecting the anomaly.

A processor-implemented method for detecting trajectory anomalies during takeoff or landing at an airdrome is disclosed. The method includes: identifying, by a processor from a received clearance message directed to a first aircraft, an approved runway and an approved landing or takeoff procedure for the first aircraft; selecting, by the processor, a runway-specific trained model appropriate for the approved procedure, the selected trained model having been trained with historical track data from other aircraft performing the approved procedure in connection with the approved runway, the selected trained model configured to provide an expected trajectory for an aircraft at different points during performance of the approved procedure in connection with the approved runway; receiving, by the processor, aircraft state information from the first aircraft at a plurality of times during performance by the first aircraft of the approved procedure; monitoring, by the processor, the received aircraft state information to determine the existence of an anomaly by comparing the received aircraft state information to expected trajectory information from the trained model; detecting, by the processor, an anomaly when the trajectory of the first aircraft deviates from the expected trajectory provided by the selected model by more than a predetermined threshold level; and generating, by the processor, an alert responsive to detecting the anomaly.

Furthermore, other desirable features and characteristics will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 is a block diagram depicting an example environment at an example airdrome that includes an example aircraft trajectory monitoring system in accordance with some embodiments;

FIG. 2 is a process flow chart depicting an example process in an example ground-based aircraft trajectory monitoring system for monitoring for aircraft trajectory anomalies, in accordance with some embodiments;

FIG. 3 is a process flow chart depicting an example process for building a runway-specific model for use in a trajectory monitoring system and an example process for using a runway-specific model to identify trajectory anomalies, in accordance with some embodiments;

FIG. 4 is a block diagram depicting an example environment at an example airdrome that includes an example aircraft trajectory monitoring system, in accordance with some embodiments;

FIG. 5 is a process flow chart depicting an example process in an example aircraft-based aircraft trajectory monitoring system for monitoring for aircraft trajectory anomalies, in accordance with some embodiments; and

FIG. 6 is a process flow chart depicting an example process for detecting trajectory anomalies during takeoff or landing at an airdrome, in accordance with some embodiments.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

The subject matter described herein discloses apparatus, systems, techniques and articles for aircraft trajectory (lateral/vertical) monitoring at or near an airdrome. The apparatus, systems, techniques and articles provided can compare an aircraft's trajectory to historical trajectory data using data analytics techniques and detect an anomaly when the aircraft's trajectory deviates from the expected trajectory by more than a predetermined amount.

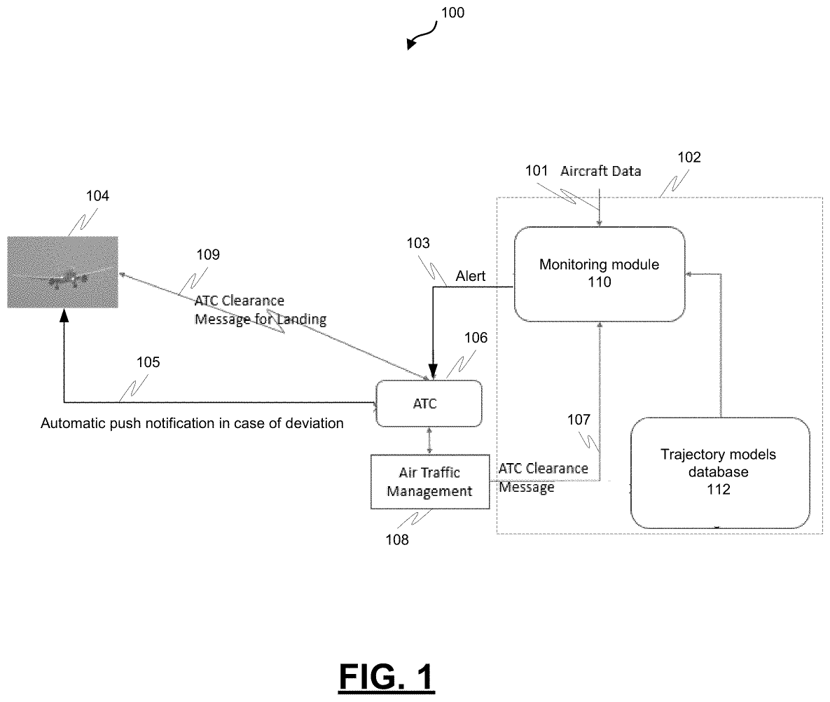

FIG. 1 is a block diagram depicting an example environment at an example airdrome 100 that includes an example aircraft trajectory monitoring system 102. The example airdrome 100 is a location from which aircraft flight operations take place, regardless of whether they involve air cargo, passengers, or neither. The example airdrome 100 may be a small general aviation airfield, a large commercial airport, a military airbase, or some other place where aircraft flight operations may take place. Depicted at the example airdrome 100 is an aircraft 104 before commencing landing operations; air traffic control (ATC) 106, which directs aircraft on the ground and through controlled airspace and which communicates with the aircraft 104 to, among other things, provide clearance messages (e.g., for takeoff or for landing); an air traffic management (ATM) system 108 that assists aircraft to depart from the airdrome, transit airspace, and land at the airdrome; and the aircraft trajectory monitoring system 102.

The example aircraft trajectory monitoring system 102 is configured to detect trajectory anomalies of aircraft 104 during takeoff and landing at an airdrome and report the anomaly to ATC 106 and/or the flight crew on the aircraft 104 to allow for corrective action. The example aircraft trajectory monitoring system 102 is configured to monitor aircraft movement around the airdrome 100 (both on the ground and in the airspace) and provide an alert (e.g., audible or visual) when it detects an anomaly with an aircraft's movement around the airdrome 100. The example aircraft trajectory monitoring system 102 is configured to identify an anomaly by comparing (e.g., using data analytics techniques) actual aircraft trajectory information 101 to a model of an expected aircraft trajectory for an aircraft interacting with a specific runway that has been developed using historical trajectory data. When an anomaly is identified, the example aircraft trajectory monitoring system 102 is configured to inform ATC 106, e.g., via an alert notification 103, and ATC 106 may, in turn, inform the aircraft (e.g., aircraft 104) experiencing the anomaly, e.g., via an anomaly notification 105. In some examples, the example aircraft trajectory monitoring system 102 may directly inform the aircraft 104 of the anomaly in addition to or instead of informing ATC 106.

The example aircraft trajectory monitoring system 102 is configured to monitor for trajectory anomalies occurring during an aircraft's approach phase and during taxiing (both during landing and takeoff). During the approach phase, the example aircraft trajectory monitoring system 102 considers the aircraft's approach trajectory toward a specific runway and a runway-specific model that has been built based on historical approach trajectory data for aircraft approaching and landing at that specific runway. During taxiing, the example aircraft trajectory monitoring system 102 considers the aircraft's movement at the specific runway and a runway-specific model that has been built based on historical surface movement data for aircraft taxiing at that specific runway.

The example aircraft trajectory monitoring system 102 is configured to receive a copy 107, e.g., via the ATM system, of the ATC clearance message 109 (voice or text) that has been provided to the aircraft 104, automatically interpret the ATC clearance message 107 to identify a specific runway to which the aircraft 104 will land or from which the aircraft 104 will takeoff, and use the identification of the specific runway to automatically identify and fetch a runway-specific model, e.g., from a trajectory models database 112, for use when monitoring for anomalies.

The example aircraft trajectory monitoring system 102 includes a monitoring module 110 and the trajectory models database 112. The example trajectory models database 112 includes a plurality of runway-specific trajectory models, each of which has been built off-line using historical data of a plurality of aircraft performing approach, landing, takeoff, or taxiing maneuvers with respect to the specific runway. During run-time, the example monitoring module is configured to apply current aircraft data 101 to an appropriate runway-specific model and continuously monitor for an unacceptable deviation from an expected aircraft trajectory using the runway-specific model. The example monitoring module is configured to apply a predetermined threshold level of deviation to determine whether a monitored deviation is acceptable or unacceptable. The example monitoring module is configured to generate an alert message when the threshold level is exceeded.

The example aircraft trajectory monitoring system 102 is an on-ground system, but in other examples an aircraft trajectory monitoring system 102 could be incorporated onboard the aircraft in aircraft systems or onboard the aircraft on a mobile device such as a mobile computer (e.g., a tablet computer, a laptop computer, or a netbook computer); a smartphone; a phablet, a video game device; a digital media player; a piece of home entertainment equipment; a digital camera or video camera; a wearable computing device (e.g., smart watch, smart glasses, smart clothing); or the like.

The example aircraft trajectory monitoring system 102 includes a controller that is configured to implement the monitoring module 110 and the trajectory models database 112. The controller includes at least one processor and a computer-readable storage device or media encoded with programming instructions for configuring the controller. The processor may be any custom-made or commercially available processor, a central processing unit (CPU), a graphics processing unit (GPU), an application specific integrated circuit (ASIC), a field programmable gate array (FPGA), an auxiliary processor among several processors associated with the controller, a semiconductor-based microprocessor (in the form of a microchip or chip set), any combination thereof, or generally any device for executing instructions.

The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the processor is powered down. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable programming instructions, used by the controller.

The example monitoring module 110 is configured receive a runway clearance message 107 (e.g., voice or text) from ATC 106 or an ATM system 108 for landing or takeoff directed to a first aircraft. The example monitoring module 110 is configured to identify, from the received clearance message, an approved runway and an approved landing or takeoff procedure for the first aircraft. The example monitoring module 110 is configured to receive aircraft state information (e.g., aircraft code, position, speed, altitude, heading, etc.) from the first aircraft at a plurality of times during performance by the first aircraft of the approved procedure.

The example monitoring module 110 is configured select a runway-specific trained model appropriate for the approved procedure based on the approved runway and approved procedure, wherein the selected trained model was trained using machine learning-based models or systems (e.g., clustering approach) with historical track data from other aircraft performing the approved procedure in connection with the approved runway. The selected trained model is configured to provide an expected trajectory for an aircraft at different points during performance of the approved procedure in connection with the approved runway. The historical track data from other aircraft used to train the runway-specific trained model may include position, speed, altitude, and heading data during past performances by the other aircraft of the approved procedure in connection with the approved runway. The example monitoring module 110 may select the runway-specific trained model from a trajectory models database associated with the aircraft trajectory monitoring system 102. The example trajectory models database 112 may physically reside with the example monitoring module 110 or may be provided by a cloud-based service.

The example monitoring module 110 is configured to monitor the received aircraft state information to determine the existence of an anomaly by comparing the received aircraft state information to expected trajectory information from the trained model using data analytics and identifying an anomaly when the trajectory of the first aircraft deviates from the expected trajectory provided by the selected model by more than a predetermined threshold level. The example monitoring module 110 is further configured to generate an alert responsive to detection of the anomaly.

The example trajectory models database 112 may physically reside with the example monitoring module 110 or may be provided by a cloud-based service. The example trajectory models database 112 includes a plurality of trained runway-specific trajectory models, each of which has been built off-line using historical data of a plurality of aircraft performing approach, landing, takeoff, or taxiing maneuvers with respect to the specific runway. The plurality of trained models include, with respect to a specific runway, a plurality of a trained model for takeoff, a trained model for approach, a trained model for landing, a trained model for taxiing after landing, and a trained model for taxiing before takeoff. The example trained models having been trained using machine learning-based models or systems (e.g., clustering approach) with historical track data from other aircraft performing the approved procedure in connection with the approved runway. The trained models are configured to provide an expected trajectory for an aircraft at different points during performance of an approved procedure in connection with the approved runway. The historical track data from other aircraft may include position, speed, altitude, and heading data during past performances by the other aircraft of the approved procedure in connection with the approved runway.

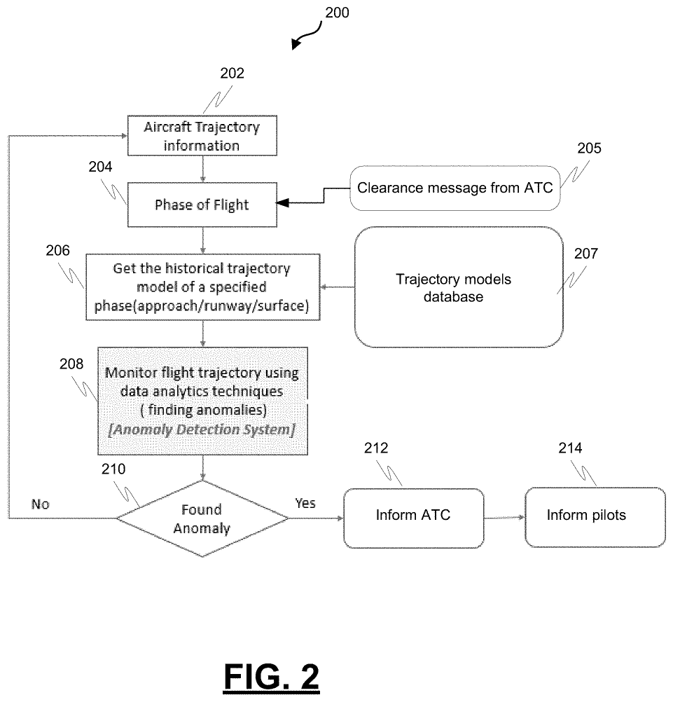

FIG. 2 is a process flow chart depicting an example process 200 in an example ground-based aircraft trajectory monitoring system 102 for monitoring for aircraft trajectory anomalies. The order of operation within the process 200 is not limited to the sequential execution as illustrated in the figure, but may be performed in one or more varying orders as applicable and in accordance with the present disclosure.

The example process 200 includes receiving aircraft state information (e.g., aircraft code, position, speed, altitude, heading, etc.) from an aircraft at a plurality of times during performance by the aircraft of the approved procedure (operation 202). The example process 200 also includes determining the phase of the aircraft's flight (e.g., approach, takeoff, landing, taxiing, etc.) (operation 204). The phase of the flight may be determined based on an ATC clearance message 205 (e.g., voice or text) directed to the aircraft and received by the aircraft trajectory monitoring system.

The example process 200 includes retrieving a runway-specific trajectory model appropriate for the phase of flight and runway (operation 206). The runway-specific trajectory model may be automatically uplinked from a cloud service using a context based uplink service. The runway may be determined based on an ATC clearance message 205. The retrieved model may be retrieved from a trajectory models database 207. The trajectory models database 207 may include a plurality of runway-specific trained models that have been trained using machine learning-based models or systems (e.g., clustering approach) with historical track data from other aircraft at the same phase of flight in connection with the same runway. The trained models may be configured to provide an expected trajectory for an aircraft at different points during the same phase of flight in connection with the same runway. The historical track data from other aircraft may include position, speed, altitude, and heading data during past performances by the other aircraft during the same phase of flight in connection with the same runway.

The example process 200 includes monitoring an aircraft's flight trajectory using data analytics and the retrieved runway-specific trained model to determine the existence of an anomaly (operation 208). This may involve comparing received aircraft state information to the trained model using data analytics and identifying an anomaly when the trajectory of the first aircraft deviates from the expected trajectory provided by the selected model by more than a predetermined threshold level.

The example process 200 includes determining if an anomaly has been detected (decision 210). If an anomaly has not been detected (no at decision 210), then the example process 200 involves continuing to receive aircraft state information (operation 202) so that monitoring can continue. If an anomaly has been detected (yes at decision 210), then the example process involves informing ATC (operation 212), which in turn informs the flight crew on the aircraft for which the anomaly has been detected (operation 214).

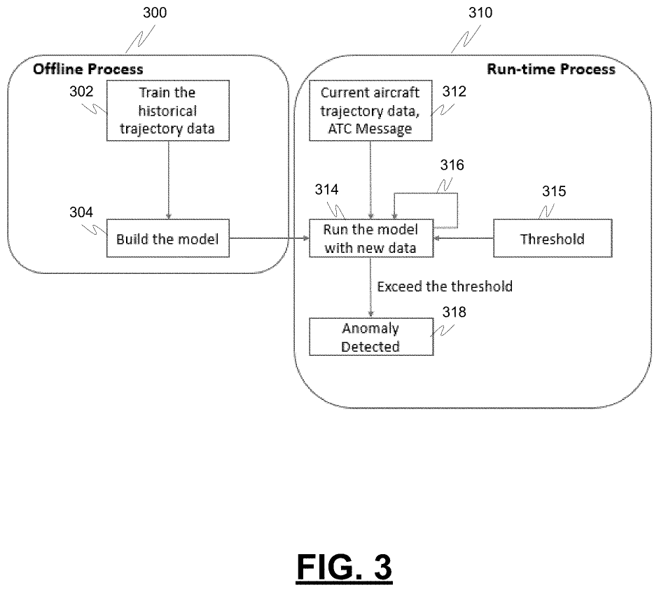

FIG. 3 is a process flow chart depicting an example process 300 for building a runway-specific model for use in a trajectory monitoring system and an example process 310 for using a runway-specific model to identify trajectory anomalies. The example process 300 includes training the historical trajectory data (operation 302) using clustering techniques to identify a range of expected trajectories for aircraft performing a specific procedure with a specific runway at different points during the specific procedure. Training the historical trajectory data may involve supervised, unsupervised, or semi-supervised clustering techniques. Training the historical trajectory data may involve using support vector machines, neural networks, Bayesian networks, or other techniques.

The example process 300 further includes building the runway-specific model from the trained historical trajectory data (operation 304). Building the runway-specific model may include training a machine learning model such as a support vector machine, neural network, Bayesian network, or other model. The trained model may be trained to compare a current aircraft trajectory to an expected trajectory for an aircraft at different points during performance of a specific procedure in connection with a specific runway and identify the level of deviation from the expected trajectory.

The example process 310 includes using the trained model to determine aircraft trajectory anomalies. The example process 310 includes receiving current aircraft trajectory data for an aircraft and an ATC clearance message for the aircraft (operation 312). Based on the ATC clearance message, a runway-specific model for a particular flight phase in which the aircraft is engaged can be selected. The selected runway-specific model can be the model built via process 300.

The example process 310 includes running the trained model with the current aircraft data to determine if an anomaly is detected (operation 314). Applying the current aircraft data to the trained model may result in the output of the amount by which the current aircraft trajectory deviates from an expected trajectory. If the deviation is less than a predetermined threshold level 315, the model will continued to monitor aircraft trajectory (operation 316). When the deviation from an expected trajectory determined by the model is greater than the predetermined threshold level 315, the example process 310 includes providing a notification that an anomaly has been detected (operation 318).

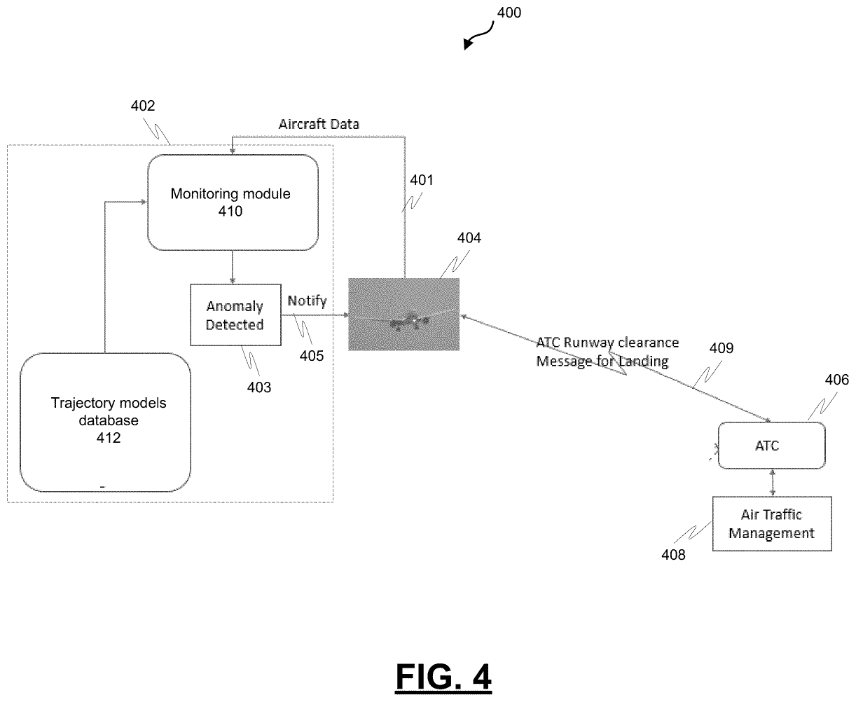

FIG. 4 is a block diagram depicting an example environment at an example airdrome 400 that includes an example aircraft trajectory monitoring system 402. Depicted at the example airdrome 400 is an aircraft 404 before commencing landing operations; air traffic control (ATC) 406, which directs aircraft on the ground and through controlled airspace and which communicates with the aircraft 404 to, among other things, provide clearance messages 409 (e.g., for takeoff or for landing); an air traffic management (ATM) system 408 that assists aircraft to depart from the airdrome, transit airspace, and land at the airdrome; and the aircraft trajectory monitoring system 402.

The example aircraft trajectory monitoring system 402 is configured to detect trajectory anomalies of the aircraft 404 during takeoff and landing at an airdrome and report the anomaly 403 to the flight crew on the aircraft 404 to allow for corrective action. The example aircraft trajectory monitoring system 402 is configured to monitor aircraft movement around the airdrome 400 (both on the ground and in the airspace) and provide an alert (e.g., audible or visual) when it detects an anomaly 403 with the aircraft's movement around the airdrome 400. The example aircraft trajectory monitoring system 402 is configured to identify an anomaly by comparing (e.g., using data analytics techniques) actual aircraft trajectory information 401 to a model of an expected aircraft trajectory for an aircraft interacting with a specific runway that has been developed using historical trajectory data. When an anomaly is identified, the example aircraft trajectory monitoring system 402 is configured to inform the aircraft flight crew, e.g., via an anomaly notification 405, which may be visual and/or audible.

The example aircraft trajectory monitoring system 402 is configured to monitor for trajectory anomalies occurring during an aircraft's approach phase and during taxiing (both during landing and takeoff). During the approach phase, the example aircraft trajectory monitoring system 402 considers the aircraft's approach trajectory toward a specific runway and a runway-specific model that has been built based on historical approach trajectory data for aircraft approaching and landing at that specific runway. During taxiing, the example aircraft trajectory monitoring system 402 considers the aircraft's movement at the specific runway and a runway-specific model that has been built based on historical surface movement data for aircraft taxiing at that specific runway.

The example aircraft trajectory monitoring system 402 is configured to receive a copy of an ATC clearance message 409 (voice or text) from aircraft systems, automatically interpret the ATC clearance message 409 to identify a specific runway to which the aircraft 404 will land or from which the aircraft 404 will take off, and use the identification of the specific runway to automatically identify and fetch a runway-specific model, e.g., from a trajectory models database 412, for use when monitoring for anomalies.

The example aircraft trajectory monitoring system 402 includes a monitoring module 410 and the trajectory models database 412. The example trajectory models database 412 includes a plurality of runway-specific trajectory models, each of which has been built off-line using historical data of a plurality of aircraft performing approach, landing, takeoff, or taxiing maneuvers with respect to the specific runway. During run-time, the example monitoring module is configured to apply current aircraft data 401 to an appropriate runway-specific model and continuously monitor for an unacceptable deviation from an expected aircraft trajectory using the runway-specific model. The example monitoring module is configured to apply a predetermined threshold level of deviation to determine whether a monitored deviation is acceptable or unacceptable. The example monitoring module is configured to generate an alert message when the threshold level is exceeded.

The example aircraft trajectory monitoring system 402 is incorporated onboard the aircraft 404 in aircraft systems or onboard the aircraft 404 on a mobile device such as a mobile computer (e.g., a tablet computer, a laptop computer, or a netbook computer); a smartphone; a phablet, a video game device; a digital media player; a piece of home entertainment equipment; a digital camera or video camera; a wearable computing device (e.g., smart watch, smart glasses, smart clothing); or the like.

The example monitoring module 410 is configured receive a runway clearance message 409 (e.g., voice or text) for landing or takeoff automatically from aircraft systems. The example monitoring module 410 is configured to identify, from the received clearance message, an approved runway and an approved landing or takeoff procedure for the aircraft 404. The example monitoring module 410 is configured to receive aircraft state information (e.g., aircraft code, position, speed, altitude, heading, etc.) from the aircraft at a plurality of times during performance by the aircraft of the approved procedure.

The example monitoring module 410 is configured select a runway-specific trained model appropriate for the approved procedure based on the approved runway and approved procedure, wherein the selected trained model was trained using machine learning-based models or systems (e.g., clustering approach) with historical track data from other aircraft performing the approved procedure in connection with the approved runway. The selected trained model is configured to provide an expected trajectory for the aircraft 404 at different points during performance of the approved procedure in connection with the approved runway. The historical track data from other aircraft used to train the runway-specific trained model may include position, speed, altitude, and heading data during past performances by the other aircraft of the approved procedure in connection with the approved runway. The example monitoring module 410 may select the runway-specific trained model from a trajectory models database associated with the aircraft trajectory monitoring system 402. The example trajectory models database 412 may physically reside with the example monitoring module 410 or may be provided by a cloud-based service.

The example monitoring module 410 is configured to monitor the received aircraft state information to determine the existence of an anomaly by comparing the received aircraft state information to expected trajectory information from the trained model using data analytics and identifying an anomaly when the trajectory of the first aircraft deviates from the expected trajectory provided by the selected model by more than a predetermined threshold level. The example monitoring module 410 is further configured to generate an alert responsive to detection of the anomaly.

The example trajectory models database 412 includes a plurality of trained runway-specific trajectory models, each of which has been built off-line using historical data of a plurality of aircraft performing approach, landing, takeoff, or taxiing maneuvers with respect to the specific runway. The plurality of trained models include, with respect to a specific runway, a plurality of a trained model for takeoff, a trained model for approach, a trained model for landing, a trained model for taxiing after landing, and a trained model for taxiing before takeoff. The example trained models having been trained using machine learning-based models or systems (e.g., clustering approach) with historical track data from other aircraft performing the approved procedure in connection with the approved runway. The trained models are configured to provide an expected trajectory for an aircraft at different points during performance of an approved procedure in connection with the approved runway. The historical track data from other aircraft may include position, speed, altitude, and heading data during past performances by the other aircraft of the approved procedure in connection with the approved runway.

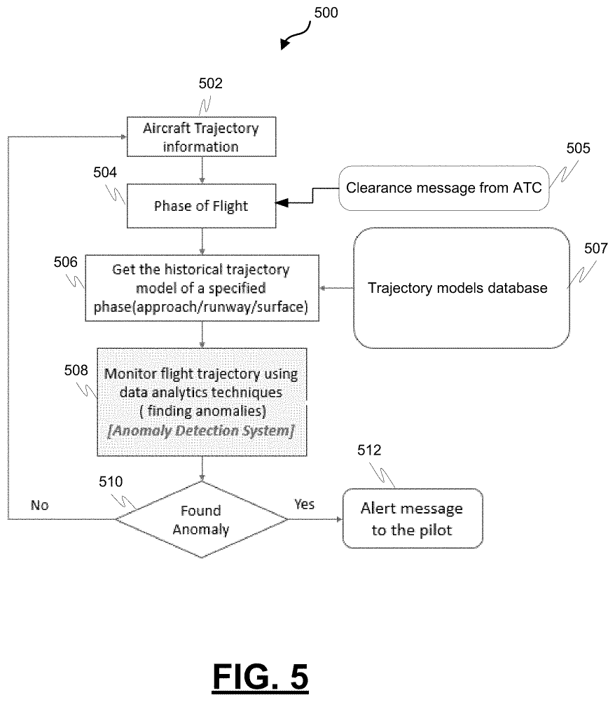

FIG. 5 is a process flow chart depicting an example process 500 in an example aircraft-based aircraft trajectory monitoring system 402 for monitoring for aircraft trajectory anomalies. The order of operation within the process 500 is not limited to the sequential execution as illustrated in the figure, but may be performed in one or more varying orders as applicable and in accordance with the present disclosure.

The example process 500 includes receiving aircraft state information (e.g., aircraft code, position, speed, altitude, heading, etc.) from an aircraft at a plurality of times during performance by the aircraft of the approved procedure (operation 502). The example process 500 also includes determining the phase of the aircraft's flight (e.g., approach, takeoff, landing, taxiing, etc.) (operation 504). The phase of the flight may be determined based on an ATC clearance message 505 (e.g., voice or text) directed to the aircraft and received by the aircraft trajectory monitoring system.

The example process 500 includes retrieving a runway-specific trajectory model appropriate for the phase of flight and runway (operation 506). The runway may be determined based on an ATC clearance message 505. The retrieved model may be retrieved from a trajectory models database 507. The trajectory models database 507 may include a plurality of runway-specific trained models that have been trained using machine learning-based models or systems (e.g., clustering approach) with historical track data from other aircraft at the same phase of flight in connection with the same runway. The trained models may be configured to provide an expected trajectory for an aircraft at different points during the same phase of flight in connection with the same runway. The historical track data from other aircraft may include position, speed, altitude, and heading data during past performances by the other aircraft during the same phase of flight in connection with the same runway.

The example process 500 includes monitoring an aircraft's flight trajectory using data analytics and the retrieved runway-specific trained model to determine the existence of an anomaly (operation 508). This may involve comparing received aircraft state information to expected trajectory information from the trained model using data analytics and identifying an anomaly when the trajectory of the first aircraft deviates from the expected trajectory provided by the selected model by more than a predetermined threshold level.

The example process 500 includes determining if an anomaly has been detected (decision 510). If an anomaly has not been detected (no at decision 510), then the example process 500 involves continuing to receive aircraft state information (operation 502) so that monitoring can continue. If an anomaly has been detected (yes at decision 510), then the example process involves informing the flight crew on the aircraft (operation 512).

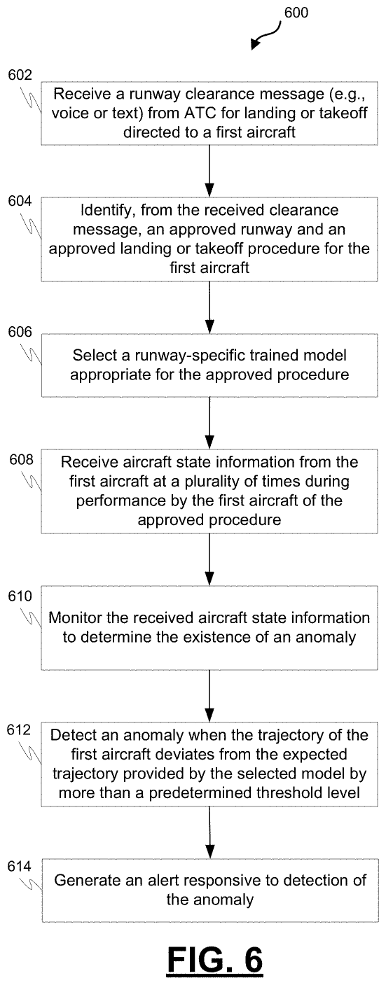

FIG. 6 is a process flow chart depicting an example process 600 for detecting trajectory anomalies during takeoff or landing at an airdrome. The order of operation within the process 600 is not limited to the sequential execution as illustrated in the figure, but may be performed in one or more varying orders as applicable and in accordance with the present disclosure.

The example process 600 includes receiving, by a processor, a runway clearance message (e.g., voice or text) from ATC for landing or takeoff directed to a first aircraft (operation 602);

The example process 600 includes identifying, by the processor from the received clearance message, an approved runway and an approved landing or takeoff procedure for the first aircraft (operation 604);

The example process 600 includes selecting, by the processor, a runway-specific trained model appropriate for the approved procedure (operation 606). The selected trained model may have been trained using machine learning-based models or systems (e.g., clustering approach) with historical track data from other aircraft performing the approved procedure in connection with the approved runway. The selected trained model is configured to provide an expected trajectory for an aircraft at different points during performance of the approved procedure in connection with the approved runway. The historical track data from other aircraft may have included position, speed, altitude, and heading data during past performances by the other aircraft of the approved procedure in connection with the approved runway. The selected runway-specific trained model may have been pre-loaded onboard the first aircraft prior to flight, automatically uplinked onboard the first aircraft using cloud services based on entering the vicinity of the airdrome region, or automatically uplinked using a context based uplink service.

The example process 600 includes receiving, by the processor, aircraft state information (e.g., aircraft code, position, speed, altitude, heading, etc.) from the first aircraft at a plurality of times during performance by the first aircraft of the approved procedure (operation 608);

The example process 600 includes monitoring, by the processor, the received aircraft state information to determine the existence of an anomaly by comparing the received aircraft state information to expected trajectory information from the trained model using data analytics (operation 610) and detecting an anomaly when the trajectory of the first aircraft deviates from the expected trajectory provided by the selected model by more than a predetermined threshold level (operation 612).

The example process 600 includes generating, by the processor, an alert responsive to detection of the anomaly (operation 614). The alert may be an audible message or a visual message. The method may be performed in a ground-based system and may include automatically providing the alert to ATC and may also include automatically providing the alert to the flight crew on the first aircraft. The method may be performed onboard the first aircraft and may include automatically providing the alert to the flight crew on the first aircraft. The method may be performed by a system that is integrated within the first aircraft. The method may be performed by a system that is integrated within a handheld device on the first aircraft. The method may be performed onboard the first aircraft and the selected runway-specific trained model may be pre-loaded onboard the first aircraft prior to flight, automatically uplinked onboard the first aircraft using cloud services based on entering the vicinity of the airdrome region, or automatically uplinked using a context based uplink service.

A runway-specific trained model for a landing procedure may include an approach phase of the model and a surface movement phase of the model; a runway-specific trained model for a takeoff procedure may include a surface movement phase of the model; during an approach phase of flight by the first aircraft, the method may include comparing the current state information of the first aircraft during approach to the approach phase of the model; and during taxiing by the first aircraft, the method may include comparing the current state information of the first aircraft during taxiing to the surface movement phase of the model.

Described herein are apparatus, systems, techniques and articles for aircraft trajectory (lateral/vertical) data monitoring with historical trajectory data using data analytics techniques. The apparatus, systems, techniques and articles provided herein can provide an on the ground, automatic anomaly detection system that uses cloud services. The apparatus, systems, techniques and articles provided herein can provide an automatic notification to ATC in case of misalignment. The apparatus, systems, techniques and articles provided herein can be an enabler for smart airport operations. The apparatus, systems, techniques and articles provided herein can provide an automatic anomaly detection system using cloud services onboard an aircraft. The apparatus, systems, techniques and articles provided herein can provide an automatic notification to the pilot in case of misalignment. The apparatus, systems, techniques and articles provided herein can provide services for an approach phase, runway and surface movement operations. The apparatus, systems, techniques and articles provided herein can provide a software only solution. The apparatus, systems, techniques and articles provided herein can enhance safety and increase airport throughput. The apparatus, systems, techniques and articles provided herein can provide an integrated solution for electronic flight bag (EFB) applications.

In one embodiment, a processor-implemented system for detecting trajectory anomalies during takeoff or landing at an airdrome is provided. The system comprises one or more processors configured by programming instructions on computer readable media. The system is configured to: receive a runway clearance message (e.g., voice or text) from ATC for landing or takeoff directed to a first aircraft; identify, from the received clearance message, an approved runway and an approved landing or takeoff procedure for the first aircraft; select a runway-specific trained model appropriate for the approved procedure, wherein the selected trained model had been trained using machine learning-based models or systems (e.g., clustering approach) with historical track data from other aircraft performing the approved procedure in connection with the approved runway, wherein the selected trained model is configured to provide an expected trajectory for an aircraft at different points during performance of the approved procedure in connection with the approved runway, and wherein the historical track data from other aircraft includes position, speed, altitude, and heading data during past performances by the other aircraft of the approved procedure in connection with the approved runway; receive aircraft state information (e.g., aircraft code, position, speed, altitude, heading, etc.) from the first aircraft at a plurality of times during performance by the first aircraft of the approved procedure; monitor the received aircraft state information to determine the existence of an anomaly by comparing the received aircraft state information to expected trajectory information from the trained model using data analytics; detect an anomaly when the trajectory of the first aircraft deviates from the expected trajectory provided by the selected model by more than a predetermined threshold level; and generate an alert responsive to detection of the anomaly.

In another embodiment, a processor-implemented system for detecting trajectory anomalies during takeoff or landing at an airdrome is provided. The system comprises one or more processors configured by programming instructions on computer readable media. The system is configured to: identify, from a received clearance message directed to a first aircraft, an approved runway and an approved landing or takeoff procedure for the first aircraft; select a runway-specific trained model appropriate for the approved procedure, wherein the selected trained model had been trained with historical track data from other aircraft performing the approved procedure in connection with the approved runway, and wherein the selected trained model is configured to provide an expected trajectory for an aircraft at different points during performance of the approved procedure in connection with the approved runway; receive aircraft state information from the first aircraft at a plurality of times during performance by the first aircraft of the approved procedure; monitor the received aircraft state information to determine the existence of an anomaly by comparing the received aircraft state information to expected trajectory information from the trained model; detect an anomaly when the trajectory of the first aircraft deviates from the expected trajectory provided by the selected model by more than a predetermined threshold level; and generate an alert responsive to detecting the anomaly.

In one embodiment, the system is further configured to receive a runway clearance message from ATC for landing or takeoff directed to the first aircraft.

In one embodiment, the runway-specific trained model has been trained using machine learning-based models or systems.

In one embodiment, the first aircraft state information includes an aircraft code, position, speed, altitude, and heading data.

In one embodiment, the system is configured to compare the received aircraft state information to the trained model using data analytics.

In one embodiment, the historical track data from other aircraft includes position, speed, altitude, and heading data during past performances by the other aircraft of the approved procedure in connection with the approved runway.

In one embodiment, the system is ground-based and further configured to automatically provide the alert to ATC.

In one embodiment, the system is further configured to automatically provide the alert to the flight crew on the first aircraft.

In one embodiment, the system is onboard the first aircraft and the system is configured to provide the alert to the flight crew onboard the first aircraft.

In one embodiment, the selected runway-specific trained model is pre-loaded onboard the first aircraft prior to flight, automatically uplinked onboard the first aircraft using cloud services based on entering the vicinity of the airdrome region, or automatically uplinked using a context based uplink service.

In one embodiment, the system is integrated within the first aircraft.

In one embodiment, the system is integrated within a handheld device.

In one embodiment, a runway-specific trained model for a landing procedure includes an approach phase of the model and a surface movement phase of the model; a runway-specific trained model for a takeoff procedure includes a surface movement phase of the model; during an approach phase of flight by the first aircraft, the system is configured to compare the current state information of the first aircraft during approach to the approach phase of the model; and during taxiing by the first aircraft, the system is configured to compare the current state information of the first aircraft during taxiing to the surface movement phase of the model.

In another embodiment, a processor-implemented method for detecting trajectory anomalies during takeoff or landing at an airdrome is provided. The method comprises: identifying, by a processor from a received clearance message directed to a first aircraft, an approved runway and an approved landing or takeoff procedure for the first aircraft; selecting, by the processor, a runway-specific trained model appropriate for the approved procedure, the selected trained model having been trained with historical track data from other aircraft performing the approved procedure in connection with the approved runway, the selected trained model configured to provide an expected trajectory for an aircraft at different points during performance of the approved procedure in connection with the approved runway; receiving, by the processor, aircraft state information from the first aircraft at a plurality of times during performance by the first aircraft of the approved procedure; monitoring, by the processor, the received aircraft state information to determine the existence of an anomaly by comparing the received aircraft state information to expected trajectory information from the trained model; detecting, by the processor, an anomaly when the trajectory of the first aircraft deviates from the expected trajectory provided by the selected model by more than a predetermined threshold level; and generating, by the processor, an alert responsive to detecting the anomaly.

In one embodiment, the method is performed in a ground-based system and further comprises automatically providing the alert to ATC.

In one embodiment, the method further comprises automatically providing the alert to the flight crew on the first aircraft.

In one embodiment, the method is performed onboard the first aircraft and further comprises automatically providing the alert to the flight crew on the first aircraft.

In one embodiment, the selected runway-specific trained model is pre-loaded onboard the first aircraft prior to flight, automatically uplinked onboard the first aircraft using cloud services based on entering the vicinity of the airdrome region, or automatically uplinked using a context based uplink service.

In one embodiment, a runway-specific trained model for a landing procedure includes an approach phase of the model and a surface movement phase of the model; a runway-specific trained model for a takeoff procedure includes a surface movement phase of the model; during an approach phase of flight by the first aircraft, the method comprises comparing the current state information of the first aircraft during approach to the approach phase of the model; and during taxiing by the first aircraft, the method comprises comparing the current state information of the first aircraft during taxiing to the surface movement phase of the model.

Non-transient computer readable media encoded with programming instructions configured to cause one or more processors to perform a method are provide. The method comprises: receiving, by a processor, a runway clearance message from ATC for landing or takeoff directed to a first aircraft; identifying, by the processor from the received clearance message, an approved runway and an approved landing or takeoff procedure for the first aircraft; selecting, by the processor, a runway-specific trained model appropriate for the approved procedure, the selected trained model having been trained using machine learning-based models or systems with historical track data from other aircraft performing the approved procedure in connection with the approved runway, the selected trained model configured to provide an expected trajectory for an aircraft at different points during performance of the approved procedure in connection with the approved runway, the historical track data from other aircraft including position, speed, altitude, and heading data during past performances by the other aircraft of the approved procedure in connection with the approved runway; receiving, by the processor, aircraft state information from the first aircraft at a plurality of times during performance by the first aircraft of the approved procedure; monitoring, by the processor, the received aircraft state information to determine the existence of an anomaly by comparing the received aircraft state information to expected trajectory information from the trained model using data analytics; detecting an anomaly when the trajectory of the first aircraft deviates from the expected trajectory provided by the selected model by more than a predetermined threshold level; and generating, by the processor, an alert responsive to detection of the anomaly.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A processor-implemented system for detecting trajectory anomalies during takeoff or landing at an airdrome, the system comprising one or more processors configured by programming instructions on computer readable media, the system configured to:
identify, from a received clearance message directed to a first aircraft, an approved runway and an approved landing or takeoff procedure for the first aircraft;
select a runway-specific trained model appropriate for the approved procedure, the selected trained model having been trained with historical track data from other aircraft performing the approved procedure in connection with the approved runway, the selected trained model configured to provide an expected trajectory for an aircraft at different points during performance of the approved procedure in connection with the approved runway;
receive aircraft state information from the first aircraft at a plurality of times during performance by the first aircraft of the approved procedure;
monitor the received aircraft state information to determine the existence of an anomaly by comparing the received aircraft state information to expected trajectory information from the trained model;
detect an anomaly when the trajectory of the first aircraft deviates from the expected trajectory provided by the selected model by more than a predetermined threshold level; and
generate an alert responsive to detecting the anomaly.

2. The system of claim 1, further configured to receive a runway clearance message from ATC for landing or takeoff directed to the first aircraft.

3. The system of claim 1, wherein the runway-specific trained model has been trained using machine learning-based models or systems.

4. The system of claim 1, wherein the first aircraft state information includes an aircraft code, position, speed, altitude, and heading data.

5. The system of claim 1, wherein the system is configured to compare the received aircraft state information to the trained model using data analytics.

6. The system of claim 1, wherein the historical track data from other aircraft includes position, speed, altitude, and heading data during past performances by the other aircraft of the approved procedure in connection with the approved runway.

7. The system of claim 1, wherein the system is ground-based and further configured to automatically provide the alert to ATC.

8. The system of claim 7, further configured to automatically provide the alert to the flight crew on the first aircraft.

9. The system of claim 1, wherein the system is onboard the first aircraft and wherein the system is configured to provide the alert to the flight crew onboard the first aircraft.

10. The system of claim 9, wherein the selected runway-specific trained model is pre-loaded onboard the first aircraft prior to flight, automatically uplinked onboard the first aircraft using cloud services based on entering the vicinity of the airdrome region, or automatically uplinked using a context based uplink service.

11. The system of claim 9, wherein the system is integrated within the first aircraft.

12. The system of claim 9, wherein the system is integrated within a handheld device.

13. The system of claim 1, wherein:
a runway-specific trained model for a landing procedure includes an approach phase of the model and a surface movement phase of the model;
a runway-specific trained model for a takeoff procedure includes a surface movement phase of the model;
during an approach phase of flight by the first aircraft, the system is configured to compare the current state information of the first aircraft during approach to the approach phase of the model; and
during taxiing by the first aircraft, the system is configured to compare the current state information of the first aircraft during taxiing to the surface movement phase of the model.

14. A processor-implemented method for detecting trajectory anomalies during takeoff or landing at an airdrome, the method comprising:
identifying, by a processor from a received clearance message directed to a first aircraft, an approved runway and an approved landing or takeoff procedure for the first aircraft;
selecting, by the processor, a runway-specific trained model appropriate for the approved procedure, the selected trained model having been trained with historical track data from other aircraft performing the approved procedure in connection with the approved runway, the selected trained model configured to provide an expected trajectory for an aircraft at different points during performance of the approved procedure in connection with the approved runway;
receiving, by the processor, aircraft state information from the first aircraft at a plurality of times during performance by the first aircraft of the approved procedure;
monitoring, by the processor, the received aircraft state information to determine the existence of an anomaly by comparing the received aircraft state information to expected trajectory information from the trained model;
detecting, by the processor, an anomaly when the trajectory of the first aircraft deviates from the expected trajectory provided by the selected model by more than a predetermined threshold level; and
generating, by the processor, an alert responsive to detecting the anomaly.

15. The method of claim 14, wherein the method is performed in a ground-based system and further comprising automatically providing the alert to ATC.

16. The method of claim 15, further comprising automatically providing the alert to the flight crew on the first aircraft.

17. The method of claim 14, wherein the method is performed onboard the first aircraft and further comprising automatically providing the alert to the flight crew on the first aircraft.

18. The method of claim 17, wherein the selected runway-specific trained model is pre-loaded onboard the first aircraft prior to flight, automatically uplinked onboard the first aircraft using cloud services based on entering the vicinity of the airdrome region, or automatically uplinked using a context based uplink service.

19. The method of claim 14, wherein:
a runway-specific trained model for a landing procedure includes an approach phase of the model and a surface movement phase of the model;
a runway-specific trained model for a takeoff procedure includes a surface movement phase of the model;
during an approach phase of flight by the first aircraft, the method comprises comparing the current state information of the first aircraft during approach to the approach phase of the model; and
during taxiing by the first aircraft, the method comprises comparing the current state information of the first aircraft during taxiing to the surface movement phase of the model.

20. Non-transient computer readable media encoded with programming instructions configured to cause one or more processors to perform a method, the method comprising:
receiving, by a processor, a runway clearance message from ATC for landing or takeoff directed to a first aircraft;
identifying, by the processor from the received clearance message, an approved runway and an approved landing or takeoff procedure for the first aircraft;
selecting, by the processor, a runway-specific trained model appropriate for the approved procedure, the selected trained model having been trained using machine learning-based models or systems with historical track data from other aircraft performing the approved procedure in connection with the approved runway, the selected trained model configured to provide an expected trajectory for an aircraft at different points during performance of the approved procedure in connection with the approved runway, the historical track data from other aircraft including position, speed, altitude, and heading data during past performances by the other aircraft of the approved procedure in connection with the approved runway;
receiving, by the processor, aircraft state information from the first aircraft at a plurality of times during performance by the first aircraft of the approved procedure;
monitoring, by the processor, the received aircraft state information to determine the existence of an anomaly by comparing the received aircraft state information to expected trajectory information from the trained model using data analytics;
detecting an anomaly when the trajectory of the first aircraft deviates from the expected trajectory provided by the selected model by more than a predetermined threshold level; and
generating, by the processor, an alert responsive to detection of the anomaly.
